(19) United States
(12) Patent Application Publication
(10) Pub. No.: US 2010/0011280 A1
(43) Pub. Date: Jan. 14, 2010

(54) Forms Management System

(76) Inventors: Lakshmi Kutty Cheeniyil, Bangalore Karnataka (IN); Sriganesh Madhvanath, Bangalore Karnataka (IN); Anjaneyulu Seetha Rama Kuchibhotla, Bangalore (IN); Jose Antonio Magana Mesa, Barcelona (ES); Joan Bosch Sole, Barcelona (ES); Eric Erickson, Gava (ES); Swaminathan Packirisami, Bangalore Karnataka (IN); Rajesh Balamohan, Bangalore Karnataka (IN)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/162,484

(22) PCT Filed: Jan. 30, 2006
(86) PCT No.: PCT/IN06/00029

§ 371 Date: Aug. 19, 2009

(51) Int. Cl. G06F 17/00

(52) U.S. Cl. 715/223; 715/224

(57) ABSTRACT

An electronic forms management system is provided. The electronic forms management system includes a publishing unit, a data input unit and a server. The publishing unit is adapted to publish the form templates to the server. The data input unit is connected to the server, and is adapted to receive input data. The server is adapted to process the published form templates and the input data. In addition, the server includes an Intelligent Character Recognition (ICR) framework which is being adapted to receive one or more ICR engines for recognizing the input data.

### FIELD OF THE INVENTION

This invention relates generally to forms filling, and more particularly, to a forms management system.

### BACKGROUND OF THE INVENTION

Emerging markets are characterized by numerous paper-based processes, a prime example of which is the filling of paper forms. Despite a number of these processes being computerized at the back-end, the interface of paper forms to end-users has remained essentially unchanged over the years. This has led to a “last mile” (or a “first mile”) problem in automating the processes. Forms filled in manually by an end-user have to be re-entered by an operator, a process that is inefficient and prone to errors. Given the widespread use of handwriting, low penetration of computers and the Internet, together with the complexity of many local scripts, electronic form-filling solutions with pen-based interfaces and handwriting input appear to have real potential.

Pen-based interfaces and handwriting input may be supported using a number of devices/technologies capable of sensing “digital ink”, i.e. the position of a suitable stylus or digital pen while writing, although the writing surface and degree of interactivity may vary substantially from device to device. For instance, a PDA or TabletPC-like device allows highly interactive filling of a form rendered on the device's display using the device's stylus; the same may be simulated using a desktop PC with an external digitizing tablet and stylus. On the other hand, devices such as PC Notes Taker from Pegasus and Anoto Digital Pen allow the filling of forms printed on special or ordinary paper and uploading the captured input to a computer in real-time or batch fashion. However, any of the solutions mentioned above must satisfy contextual constraints such as bearable cost of technology, available nature of connectivity, need for real-time response/interactivity, required accuracy of transcription, feasibility of manual verification, available time for capturing, environment constraints (e.g. portability, ruggedness) and profile of users.

Developed markets also face issues of manual data entry and re-entry despite markedly higher penetration of computers and networks. Governments and businesses continue to rely on management processes based on paper-based forms due to their simplicity, legal requirements for paper copies, and high acceptance by the end user both in terms of their mobility and intuitiveness. In fact, prior art electronic forms capture solutions based on PCs with keyboards have made relatively small inroads into a market in which about 100 billion forms are filled out each year. Here too, electronic form-filling solutions with pen-based interfaces appear to have a real potential.

Accordingly, it is desirable to have a framework that supports publishing, processing and management of forms.

### SUMMARY OF THE INVENTION

According to an embodiment, an electronic forms management system is provided. The electronic forms management system includes a publishing unit, a data input unit and a server. The publishing unit is adapted to publish form templates to the server. The data input unit is connected to the server, and is adapted to receive input data. The server is adapted to process the published form templates and the input data. In addition, the server includes an Intelligent Character Recognition (ICR) framework which is being adapted to receive one or more ICR engines for recognizing the input data.

### BRIEF DESCRIPTION OF THE DRAWINGS

The embodiments of the invention will be better understood in view of the following drawings and the detailed description.

FIG. 1 shows a block diagram of an electronic forms management system.

FIG. 2 shows a block diagram of an electronic forms management system according to an embodiment.

FIG. 3 shows a block diagram of an example of the electronic forms management system according to another embodiment.

FIG. 4 shows an example of how the ICR framework interacts with a program application according to an embodiment.

FIG. 5 shows an example of the device framework supporting three different data input devices according to an embodiment.

FIG. 6 shows an example of a solution architecture of the electronic forms management system according to an embodiment.

FIG. 7 shows a flow-chart of a process of an end-user filling a form according to an embodiment.

### DETAILED DESCRIPTION OF THE INVENTION

FIG. 1 shows a block diagram of an electronic forms management system 100. The electronic forms management system 100 includes an input device 101, a server 102 and a backend system 103. The input device 101 may be any device that supports the capture of digital ink or allows the entry of text using traditional or “soft” keyboards.

The server 102 is an application program which resides in a computer. The server 102 receives input data from the input device 101. The server 102 processes the input data, usually in the form of digital ink or strokes, to extract useful information known as form data. Processing of the input data may include recognizing the digital strokes of the input data, and identifying the respective data fields the recognized digital strokes correspond to. The form data, which is the output of processing by the server 102, is subsequently transferred to the backend system 103. The backend system 103 may be a storage module residing in memory or in the hard disk of the computer. The backend system 103 may also be an application program, residing either in the same computer or in a remote system, which makes use of the form data to perform some specified tasks.

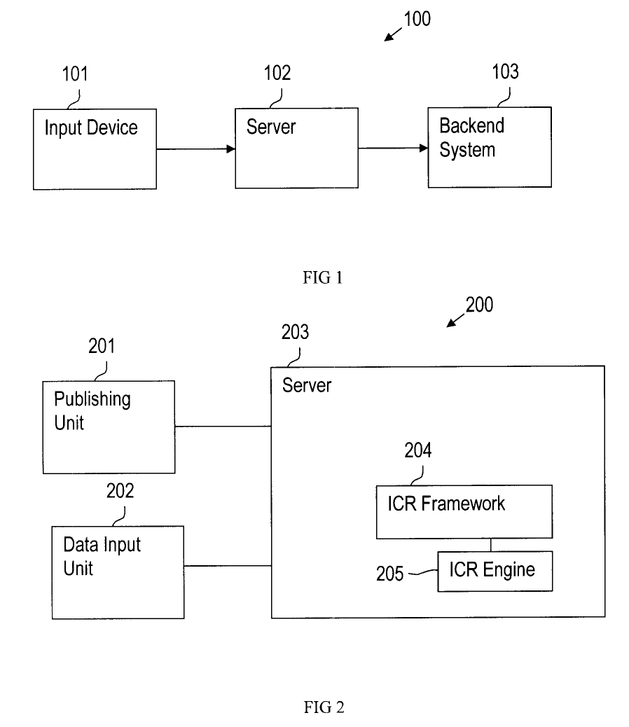

FIG. 2 shows a block diagram of an electronic forms management system 200 according to an embodiment. The electronic forms management system 200 includes a publishing unit 201 and a data input unit 202 connected to a server 203. The publishing unit 201 allows a user to publish (or upload) form templates to the server 203. The form templates may be designed using third party form designing tools such as Adobe Professional for creating form templates to be printed as paper forms for use by paper-based devices, or XForm design tools for creating form templates to be represented as interactive forms for use by interactive devices. A format suitable to be printed out on paper includes the Portable Document Format (PDF), and a format suitable to be displayed by a browser as an interactive form includes XForms. A common design tool may also be used to create and modify form templates in a common design format (for instance, Adobe XDP) that can be converted to PDF or XForms respectively for paper and interactive forms.

The data input unit 202 allows the user to provide input data to the server 203. The input data is subsequently processed by the server 203. The user provides input data by filling forms using the data input unit 202. Depending on the data input unit 202, the forms may be rendered or displayed in a format suitable to be printed out on paper, in a format suitable to be displayed by a browser or a client application as an interactive form, or both.

In an embodiment, the form is rendered by the electronic forms management system 200 in the paper format. Accordingly, the data input unit 202 is a device which supports the capture of digital ink. Examples of such devices include Anoto Pens and Pegasus Pens. When the user fills the form using the device, the device captures the digital ink and sends it to the server 203. In general, different devices may capture and send ink in different formats. In an embodiment, the server 203 uses Digital Ink Markup Language (InkML) for device and platform neutral representation of digital ink. In this embodiment, the system 200 may further include interfaces which may be implemented for each device to convert digital ink from a proprietary format to InkML. Such an interface will be described in detail later.

In an alternative embodiment, the form is rendered by the electronic forms management system 200 in the interactive format. The interactive form may be displayed in a web browser or a client application. Accordingly, the data input unit 202 is an interactive device that allows the user to provide input in the form of text input using a keyboard, or digital ink using a stylus, an external tablet or any mouse-like devices. Such interactive devices include, but are not limited to, desktop Personal Computer (PC), Personal Digital Assistant (PDA), notebook and tablet PC. Such input provided by the user in this embodiment may be directly recognized by the data input unit 202 or by the server 203. It is also possible for the input to be partially recognized by both the data input unit 202 and the server 203.

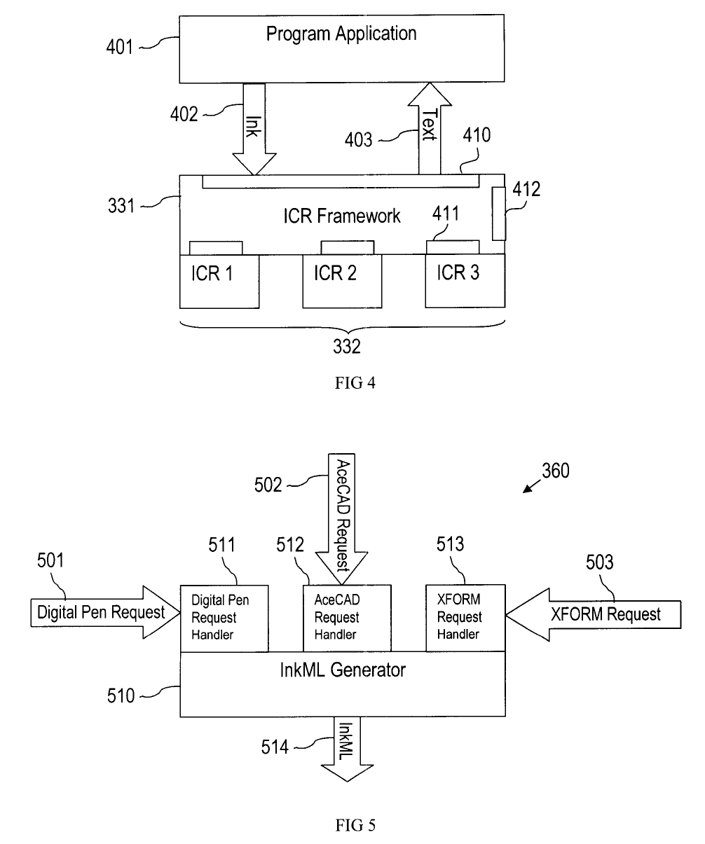

The server 203 processes the published form templates and the input data. The processing of the published form templates and the form data will be described later in greater detail. The server 203 includes an Intelligent Character Recognition (ICR) framework 204 which is adapted to receive or integrate one or more ICR engines 205 for recognizing digital ink received from the data input unit 202. The ICR framework 204 passes the digital ink to the ICR engines 205 for recognition and obtains recognition results from the ICR engines 205. The ICR Framework 204 will be described in detail later with reference to FIG. 4.

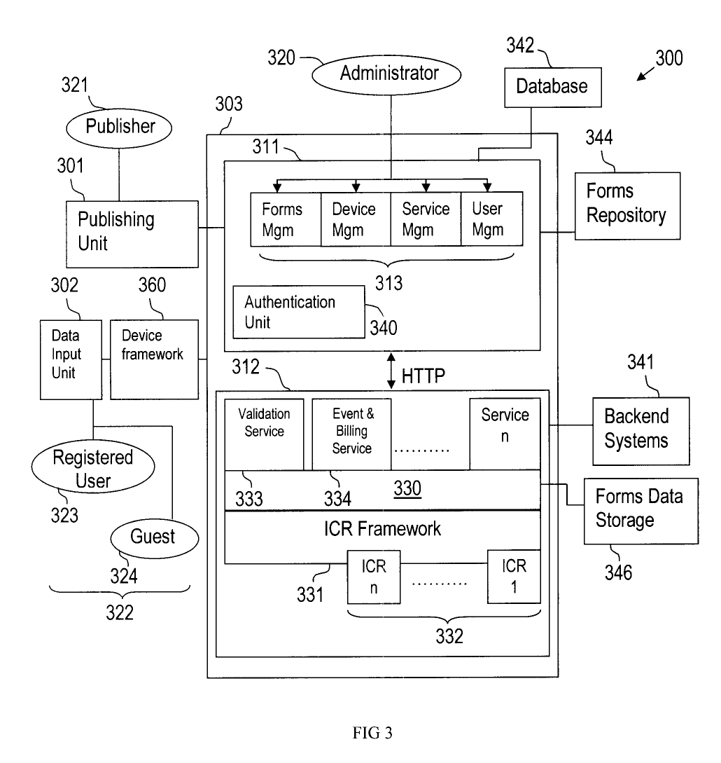

FIG. 3 shows a block diagram of an example of an electronic forms management system 300 according to an embodiment. The server 303 includes a Service Controller (SC) module 311 and a Forms Processing Service (FPS) module 312. The SC module 311 and the FPS module 312 communicate with each other via the Hyper Text Transfer Protocol (HTTP). The SC module 311 orchestrates the invocation of various services 313 that constitute a forms automation workflow solution, including form management, device management, service management and user management.

User management includes the management and administration of different kinds of users, including their respective permissions and their functions. The electronic forms management system 300 according to the embodiment supports three user roles, namely “administrator” 320, “publisher” 321 and “end-user” 322. The end-user may be further classified as “registered user” 323 and “unregistered user” 324. The unregistered user 324 is known as “guest”, and has access only to forms which are made public by the system 300. Users may be classified into user groups for ease of administration. The role of the end-user 322 is associated primarily with filling and submitting a form. Forms once submitted and processed may be available to the end-user or any other users for review and resubmission. The publisher 321 is allowed to publish form templates to the server 303, and to associate the published form templates with form processing services, which may be either a generic form processing service or specific form processing services created for the form templates. The role of the administrator 320 is associated with setting up of registered users 323 and user groups, devices and device groups, forms and form groups, the forms processing services, and the associations between these entities.

Form templates designed externally are published to the server 303 before they can be used. Forms management includes associating forms with services or pipelines of services which can process the content of the forms when submitted. Forms, like users, may be categorized into logical groups, and associated with users and user groups having the permission and task of filling them. Forms may also be designated as “public”, and therefore, made available to the unregistered users 324.

Service management includes the management and categorization of form processing services and their association with published forms. It also includes managing or orchestrating the flow in a pipeline of services configured for processing input data submitted by the end-user. Such services in the pipeline may include ICR processing, validation services and integration with backend systems.

Device management includes the management and grouping of devices (for allowing users to provide input data) registered with the system 300. Devices and device groups may be associated with specific users and user groups. Devices may also be designated as shareable or personal. In particular, a shareable device associated with a user group may be used by any member belonging to that user group.

The FPS module 312 is exposed as a web service interface. The FPS module 312 includes a generic form processing service 330 that handles forms processing. In addition, specific form processing services may be created for processing input data received from the end-user. The input data provided by the end-user is normally received by the FPS module 312, and processed into a generic XML format. The processed input data in XML format may be sent to other form processing services for additional processing as defined by the service management.

According to an embodiment, the FPS module 312 includes a validation service 333 and an event and billing service 334 as specific form processing services. The validation service 333 is adapted to verify the recognized ink data against formats such as data types, regular expressions and complex business rules. The validation service 333 can be configured through the service management, and can be defined as one of the services in a pipeline of services for processing the input data. The event and billing service 334 is adapted to capture the occurrence of various business events which can be used for billing.

In other embodiments, the specific form processing services may include:
extraction of information for a form field and page number for a form, wherein the form field information includes text field, check box, combo box or drawing area;
conversion of device-specific ink formats to a standard ink format, such as the InkML;
invocation of handwriting recognition to convert ink into text by sending digital ink along with relevant context such as language, data type and resource files to an ICR framework 331;
persistence of processed forms in a standard format such as a generic XML format;
supporting multiple form-filling sessions due to submission of partially filled forms;
supporting submission of a form using one type of data input unit and subsequent review by another type of data input unit;
transmission of a transaction status back to the device and updating the SC module 311;
passing of processed ink data in the )ML format to backend or legacy systems 341 via a standard interface such as a web service in an embodiment;
routing partially processed form data to the next service configured in the flow in the pipeline of services. The form data can be processed and updated by various services in sequence. This pipeline of services can be deployed over standard protocols like web services.

The FPS module 312 uses the ICR framework 331 to support easy integration of different ICR engines 332. An example of how the ICR framework 331 enables the integration of ICR engines 332 with a program application 401 (for example, the generic form processing service 330) according to an embodiment is shown in FIG. 4.

The ICR framework 331 includes an application interface 410 to the program application 401 for receiving digital ink 402. In an embodiment, the application interface 410 allows the program application 401 to obtain and set a recognition context for each recognition event via the application interface 410. The purpose of the recognition context is to delegate calls to actual ICR engines 332 with ink data, device context, and field context. The device context is used to capture any device specific attributes such as spatial resolution and sampling rate. The field context is used to capture any field specific attributes such as data type, pattern, length and style (for example boxed input).

The ICR framework 331 also allows a plurality of ICR engines 332 to be connected thereto. The ICR Framework 331 specifies a standard interface known as an engine interface 411 to facilitate the integration of the ICR engines 332 into the ICR framework 331. The ICR engines 332 may include proprietary ICR engines or third party ICR engines as long as they are able to interface with the engine interface 411 specified by the ICR framework 331. The engine interface 411 can either be provided natively by the ICR engines 332 or be provided as a software wrapper around a proprietary interface exposed by the ICR engines 332. The engine interface 411 allows the ICR framework 331 to load and unload an ICR engine 332, specify device properties such as sampling rate and resolution, specify characteristics of the digital ink or field such as boxed input, specify the format of digital ink (for example, ink channels such as X, Y, and pen-tip force), specify data types, word lists and other field context, and pass a field of digital ink for recognition. The recognition results obtained from the ICR engines 332 are returned to the ICR framework 331 as an array of values with different confidences.

The program application 401 invokes the ICR engines 332 by sending the digital ink 402 in the form of InkML, together with other relevant data such as language, data type and resource files, to the ICR framework 331. The ICR framework 331 invokes the ICR engine 332 specified by the program application 401 for recognizing the digital ink 402. Once the recognition process is completed, the specified ICR engine 332 outputs the recognition results to the ICR framework 331. The ICR framework 331 then returns the results 403 to the program application 401. The results 403 are text strings, and may be in Unicode or any other suitable proprietary or standard encoding in other embodiments.

The ICR framework 331 maintains a searchable registry of available ICR engines 332 for different languages and scripts. In an embodiment, the ICR framework 331 allows the program application 401 to include logic to automatically locate one or more suitable ICR engines 332 for recognizing a specific field of ink, for example based on language, script or some other attributes of the field of ink. In another embodiment, the program application 401 merely specifies these attributes of the field of ink, and the ICR Framework locates the suitable engines. Further, the ICR Framework can include logic to support combination of results from a few ICR engines 332 (for example, by selecting the most suitable engine given the input, using a voting mechanism, or a weighted combination of the ranks or confidences given by the individual engines, or any other suitable combination scheme) for the same script to improve overall recognition accuracy. The registry of available ICR engines 332 may be manipulated via a management interface 412 in the ICR Framework 331. For instance, the management interface 412 may be used to register and un-register ICR engines 332.

Different ICR engines 332 may differ in their ability to process different types of contextual information (for example, pattern or data type) passed from the ICR framework 331. Consequently, some information may be converted by the individual ICR engines 332 (or their wrappers) into their own internal forms., simplified or ignored for the purposes of recognition. In an embodiment, the ICR engines 332 communicate back to the ICR framework 331, along with the recognition results, information about how the contextual information passed from the ICR framework 33 was used. The ICR framework 331 may include logic to adjust confidences returned by different ICR engines 332 to account for such differences in the ability of ICR engines 332 to understand context, as well as differences in the recognition performance of the ICR engines 332 as assessed by the ICR Framework 331. The ICR framework 331 may also include logic to reject the results returned by ICR engines 332 based on an assessment of the confidences returned.

In an embodiment, the electronic forms management system 300 further includes a device framework 360 which supports the simultaneous use of heterogeneous input devices as the data input unit 302. FIG. 5 shows an example of the device framework 360 supporting three different input devices according to an embodiment. In this example, three different input formats, namely from a Pegasus digital pen (ink format), AceCAD (ink format) and Tablet PC running XFORM (containing ink in InkML format), are generated from the three input devices. This results in three different types of requests 501, 502, 503 to the device framework 360. The device framework 360 includes an InkML generator 510, and three device request handlers 511, 512, 513. Each of the request handlers 511, 512, 513 are adapted to parse each of the requests 501, 502, 503 of the input devices. The InkML generator 510 converts the requests 501, 502, 503 into InkML format 514, and sends them to the FPS module 312 for processing.

It is noted that the device framework 360 as described in FIG. 5 allows more than one different input device to be connected to the server 303 simultaneously. Accordingly, more than one user may provide input to the system 300 at the same time. For example, a first user fills a form on paper using a digital pen, and at the same time, a second user may fill up another form using a desktop computer. In addition, the first user who filled and submitted a form on paper to the system 300 may later review his submission using the desktop. In the event that the form was not completely filled, or if corrections need to be made, the first user may do so using the desktop.

It is also possible for an input device to be connected to the server 303 via a mobile network or the Internet. In one embodiment, an end-user accesses a form from his or her mobile phone, and fills the form. The completed form is then submitted to the server 303 via a mobile phone network, such as the Global System for Mobile Communication (GSM). In another embodiment, the end-user accesses a form using a remote computer. After filling the form, the end-user submits the completed form to the server 303 via the Internet.

The SC module 311 interfaces with a database 342 and a forms repository 344 as shown in FIG. 3. The database 342 stores form information, device information, service information and user information. The forms repository 344 stores the form templates published by the publisher 321. The system 300 also includes a form data storage 346 which interfaces with the FPS module 312. The form data storage 346 may be used for storing data such as form data.

Security features may be implemented to the system 300 to ensure the security of the transmission and processing of sensitive information, such as the personal information of the end-users 322. In an embodiment, the SC module 311 includes an authentication unit 340 which authenticates the devices or data input unit 302. The authentication of the devices may take place when the end-user 322 downloads forms from the system 300 for filling. Accordingly, the device is authenticated before data is sent from the device to the FPS module 312 for processing. The authentication of the devices by the SC module 311 may be performed using the Challenge Handshake Authentication Protocol (CHAP). The sending of input data from the device to the server 303 may also be encrypted in a further embodiment.

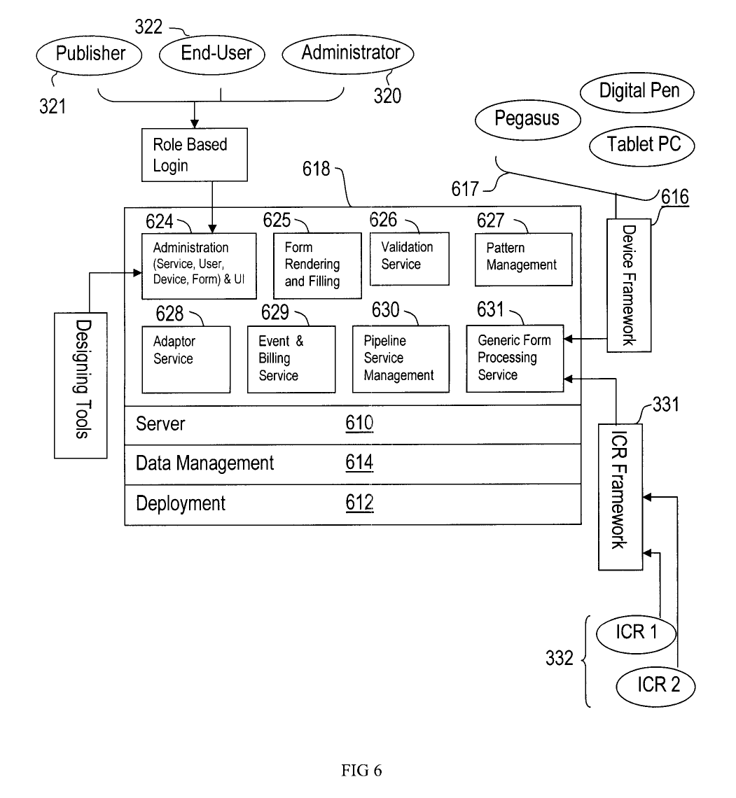

FIG. 6 shows an example of a solution architecture of the electronic forms management system 300 implemented using Service Oriented Architecture according to an embodiment. The system 300 is built on Java 2 Platform Enterprise Edition (J2EE) using an Apache Tomcat Servlet container 610, and is deployed on a Windows server 612. A structured query language (SQL) server is used to form a data management module 614. A device framework 616 is provided as a device-neutral layer which allows the server 303 to interact with different types of input devices 617.

A services module 618 is implemented in the server 303. The services module 618 includes user, device, form and service administration 624, form rendering and filling 625, validation service 626, pattern management service 627, adaptor service 628, event and billing service 629, pipeline service management 630 and generic form processing service 631. The user, device, form and service administration 624 supports the management of users, forms, devices and services as already described earlier.

The form rendering and filling 625 refers to the displaying of forms for end-user 322 to fill. As already described above, the form rendering and filling may be supported differently for paper-based and interactive-based applications. For paper-based applications, forms may be represented as PDF documents and printed on paper using a printer. For interactive-based applications, forms may be represented as web forms using the XForms standard and rendered by a web browser or a client application. The form rendering and filling 625 also includes generating and handling form instances. The handling of form instances relates to the identification and tracking of form instances by the pattern management service 627 using a unique identifier, and the contents of the form instances. For instance, in the case of Digital Pen and Paper forms, a unique identifier for a form instance may be embedded in a digital pattern at the time of printing, and read along with the ink when the form is submitted. Alternatively, a unique identifier may be generated by the server when a new form instance is received, and associated with the specific instance. For forms submitted using an interactive device, the form instance needs to be generated.

As already described above, the generic form processing service 631 parses the ink data that is sent by the device framework 616 in generic XML format. The generic form processing service 631 also invokes the ICR Framework 331 to convert the ink data into text by sending the ink data, along with relevant context such as language, data type and resource files, to the ICR Framework 331. When the ink data has been converted into text, the generic form processing service 630 receives the results from the ICR Framework 331, and generates an output in XML format so that it can be processed by the other services. The pipeline service management 630 controls the pipeline of services for processing form instance. It updates the state of the form instance and the XML output based on the results from each service call. The adaptor service 628 is used to invoke web services called by the pipeline service management 630. The adaptor service 628 hides the complexity involves in such calls (Web Service, RMI, or etc). The validations service 626 verifies the recognized ink data (output XML) and the event and billing service 629 captures the occurrence of various business events which can be used in billing, as already described above.

The pattern management service 627 handles the allocation, deallocation and reusing of patterns printed on paper forms required for some pen-input devices (for example, Anoto). Subsequently, these patterns are used to identify paper form instances and/or form templates within the system. Accordingly, the pattern management service 627 provides an interface for integrating with any supplier of a suitable pattern space (for example, Anoto). The pattern management service 627 is also invoked while printing a form with these patterns.

The data management module 614 may be used as the database for storing user, device, service and form information. It may also be used as a form repository for storing form templates and form data storage for storing form data.

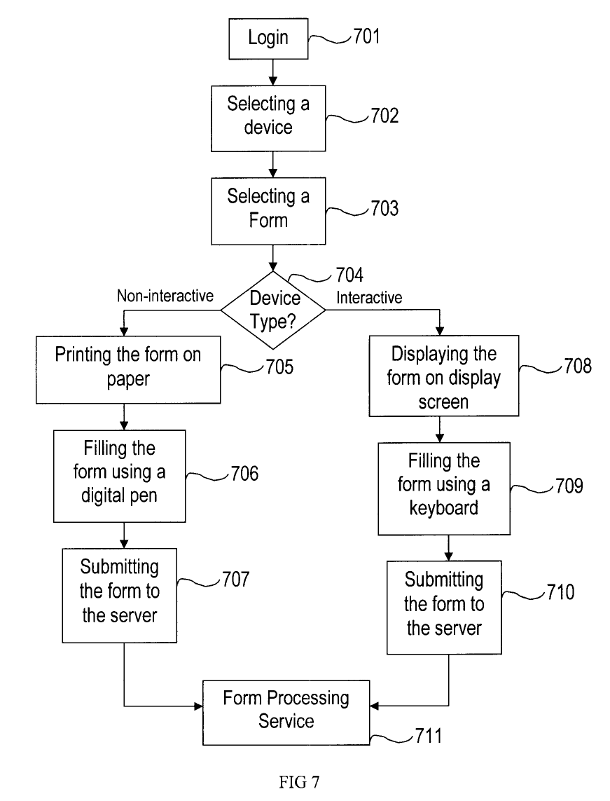

FIG. 7 shows a flow-chart of a process of an end-user filling a form according to an embodiment. Step 701 includes logging in to the electronic forms management system 300. The end-user may log in using a client computer connected to the system 300. The logging in of the end-user allows the system 300 to identify the end-user. After logging in, the end-user selects a device for form filling at step 702. Alternatively, the device may be automatically detected and selected by the system 300. Step 703 includes selecting a form to be rendered. Accordingly, the system 300 displays the selected form to the end-user. It should be noted that the sequence of steps 702 and 703 are interchangeable. The end-user may select the form before selecting the devices.

Step 704 includes determining the type of device selected by the end-user. If the device type is non-interactive, the end-user prints the form selected at step 703 onto a paper using a printer at step 705, if the selected form was not already printed. The end-user fills the form at step 706 using an ink capturing device, such as a digital pen. After filling the form using the ink capturing device, the input data, that is the digital ink captured by the device, are sent to the server 303 at step 707. It is possible that the input data in the device are first stored in a memory unit of the device. The stored data is sent to the server 303 only at a later stage, for example, when a connection is established between the device and the server 303.

When the device type is determined to be an interactive device at step 704, the system 300 displays the form directly onto a display screen of an interactive device, such as a desktop computer, at step 708. The end-user fills the form directly at the desktop computer at step 709 and submits the completed form to the server 303 at step 710. Alternatively, the end-user may download the form to the desktop computer and disconnect from the server 303. The downloaded form may be filled at a later stage, and the completed form is stored as a local file in the device. When the desktop computer is connected to the server 303, the file may be sent to the server 303 as input data. When the forms are filled, whether using non-interactive or interactive devices, the completed forms are submitted to the FPS module 312 of the server 303 for processing at Step 711.

Although the present invention has been described in accordance with the embodiments as shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. An electronic forms management system comprising:
at least one publishing unit being adapted to publish form templates to a server;
at least one data input unit connected to the server and being adapted to receive input data; and
the server being adapted to process the published form templates and the input data, wherein the server comprises an Intelligent Character Recognition (ICR) framework being adapted to receive at least one ICR engine for recognizing the input data.

2. The electronic forms management system of claim 1, further comprising a form designing tool for creating form templates.

3. The electronic forms management system of claim 1 wherein the data input unit comprises a device supporting capture of digital ink or text input.

4. The electronic forms management system of claim 3, wherein the device converts the captured digital ink into the Digital Ink Markup Language (InkML).

5. (canceled)

6. The electronic forms management system of claim 1, further comprising a device framework being adapted to interface with the at least one data input unit.

7. (canceled)

8. The electronic forms management system of claim 1, wherein when a plurality of ICR engines are received by the ICR framework, the ICR framework is adapted to:
determine at least one ICR engine suitable for recognizing the input data; and
recognize the input data using the at least one suitable ICR engine.

9. The electronic forms management system of claim 1, wherein the server comprises a service controller module in communication with a forms processing service module.

10. The electronic forms management system of claim 9, wherein the service controller module is adapted to invoke services including one or more of form management, device management, service management and user management.

11. The electronic forms management system of claim 9, further comprising a database interfaced to the service controller module for storing one or more of form information, device information, service information and user information.

12. The electronic forms management system of claim 9, wherein the forms processing service module allows form processing services to be created and exposed as web services that can be combined in a pipeline with other services.

13. The electronic forms management system of claim 12, wherein the at least one form processing service is adapted to invoke the at least one ICR engine received by the ICR framework for recognizing the input data.

14. The electronic forms management system of claim 1, further comprising a forms repository for storing form templates.

15. The electronic forms management system of claim 1, further comprising form data storage for storing form data.

16. (canceled)

17. (canceled)

18. An apparatus comprising:
an application server having at least a services layer,
wherein the application server is adapted to process form templates published from a publishing unit and input data received from a data input unit, and
wherein the services layer comprises an Intelligent Character Recognition (ICR) framework being adapted to receive at least one ICR engine for recognizing the received input data.

19. The apparatus of claim 18, wherein the services layer further comprises a device framework being adapted to interface with one or more data input units.

20. The apparatus of claim 18, wherein when a plurality of ICR engines are received by the ICR framework, the ICR framework is adapted to:
determine at least one ICR engine suitable for recognizing the input data; and
recognizing the input data using the at least one suitable ICR engine.

21. The apparatus of claim 18, wherein the services layer is adapted to support the management of users, forms, services and devices.

22. The apparatus of claim 18, wherein the services layer is exposed as a web service interface which allows form processing services to be created and exposed as web services.

23. The apparatus of claim 22, wherein at least one form processing services is adapted to invoke the at least one ICR engine received by the ICR framework for recognizing the input data.

24. The apparatus of claim 18, further comprising a data management layer for storing one or more of the following:
information on forms, devices, services and users;
form templates; and
form data.

25. (canceled)

26. (canceled)
